(19) United States
(12) Patent Application Publication
(10) Pub. No.: US 2026/0280938 A1
(43) Pub. Date: Sep. 17, 2026

(54) CHANNEL ESTIMATION IN COMMUNICATIONS

(71) Applicant: Nokia Solutions and Networks Oy, Espoo (FI)

(72) Inventors: Laurent VALLETTE, Massy (FR); Pierre JACOLOT, Massy (FR)

(21) Appl. No.: 19/557,296

(22) Filed: Mar. 5, 2026

(30) Foreign Application Priority Data
Mar. 17, 2025 (FI) 20255217

(51) Int. Cl. H04L 25/02; H04B 7/06

(52) U.S. Cl. CPC H04L 25/0202; H04B 7/0639

(57) ABSTRACT

An apparatus (104) is disclosed, which may, based on an initial channel estimation of sounding signals (1301), perform channel extraction (1302) by extracting a propagation channel into a dominant resolvable cluster channel model and a residual channel model. The apparatus (104) may use the dominant resolvable cluster channel model as an input to precoding (1302) with a channel model precoder.

### FIELD

The following example embodiments relate to wireless communication.

### BACKGROUND

Precoding in a massive MIMO system may be performed by a gNB, wherein user device specific sounding signals may be utilized by the gNB to analyze a spatial propagation channel of the user device and to optimize the computation of beam weight vectors.

### SUMMARY

The scope of protection sought for various example embodiments is set out by the independent claims. The example embodiments and features, if any, described in this specification that do not fall under the scope of the independent claims are to be interpreted as examples useful for understanding various embodiments.

According to a first aspect, there is provided a method comprising:
based on an initial channel estimation of sounding signals, performing, by an apparatus, channel extraction by extracting a propagation channel into a first dominant resolvable cluster channel model and a first residual channel model; and
using, by the apparatus, the first dominant resolvable cluster channel model as a first input to precoding with a channel model precoder.

According to a second aspect, there is provided an apparatus comprising means for causing the apparatus to perform at least the method of the first aspect.

According to a third aspect, there is provided an apparatus comprising at least one processor, and at least one memory storing instructions that, when executed by the at least one processor, cause the apparatus to perform at least the method of the first aspect.

According to a fourth aspect, there is provided a non-transitory computer readable medium comprising program instructions which, when executed by an apparatus, cause the apparatus to perform at least the method of the first aspect.

### BRIEF DESCRIPTION OF THE DRAWINGS

In the following, various example embodiments will be described in greater detail with reference to the accompanying drawings, in which

FIG. 1 illustrates an example of a wireless communication network;

FIG. 2 illustrates two non-resolvable directions in an antenna array pattern;

FIG. 3 illustrates antenna array artifacts in a beam pattern;

FIG. 4 illustrates angular distribution of energy received by an antenna array;

FIG. 5 illustrates sounding signals processing according to an exemplary embodiment;

FIG. 6 illustrates D-RCC channel extraction according to an exemplary embodiment;

FIG. 7 illustrates D-RCC parameter estimation according to an exemplary embodiment;

FIG. 8 illustrates D-RCC modelling according to an exemplary embodiment;

FIG. 9 illustrates D-RCC scaling according to an exemplary embodiment;

FIG. 10 illustrates D-RCC channel extraction according to an exemplary embodiment;

FIG. 11 illustrates an exemplary channel estimated from sounding signals;

FIG. 12 illustrates an exemplary channel pruned from sounding signals;

FIG. 13 illustrates a signal flow diagram according to an exemplary embodiment;

FIG. 14 illustrates a flow chart according to an exemplary embodiment;

FIG. 15 illustrates an exemplary apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments within the scope of the claims. Furthermore, the words “comprising” and “including” should be understood as not limiting the described embodiments to consist of only those features that have been mentioned, and such embodiments may also contain features that have not been specifically mentioned. Reference numbers, in the description and/or in the claims, serve to illustrate the embodiments with reference to the drawings, without limiting the embodiments to these examples only.

Some example embodiments described herein may be implemented in a wireless communication network comprising a radio access network based on one or more of the following radio access technologies (RATs): global system for mobile communications (GSM) or any other second generation (2G) radio access technology, universal mobile telecommunication system (UMTS, 3G) based on basic wideband-code division multiple access (W-CDMA), high-speed packet access (HSPA), long term evolution (LTE), LTE-Advanced, fourth generation (4G), fifth generation (5G), 5G new radio (NR), 5G-Advanced (i.e., 3GPP NR Rel-18 and beyond), sixth generation (6G), or seventh generation (7G). Some examples of radio access networks include the universal mobile telecommunications system (UMTS) radio access network (UTRAN), the evolved universal terrestrial radio access network (E-UTRA), or the next generation radio access network (NG-RAN). The wireless communication network may further comprise a core network, and some example embodiments may also be applied to network functions of the core network.

It should be noted that the embodiments are not restricted to the wireless communication network given as an example, but a person skilled in the art may also apply the solution to other wireless communication networks or systems provided with necessary properties. For example, some example embodiments may also be applied to a communication system based on IEEE 802.11 specifications, or a communication system based on IEEE 802.15 specifications. IEEE is an abbreviation for the Institute of Electrical and Electronics Engineers.

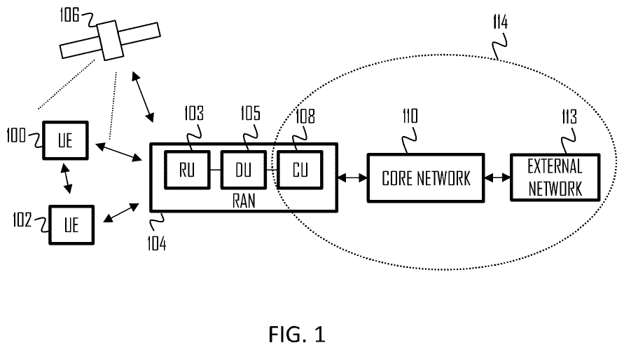

FIG. 1 depicts an example of a simplified wireless communication network showing some physical and logical entities. The connections shown in FIG. 1 may be physical connections or logical connections. It is apparent to a person skilled in the art that the wireless communication network may also comprise other physical and logical entities than those shown in FIG. 1.

The example embodiments described herein are not, however, restricted to the wireless communication network given as an example but a person skilled in the art may apply the example embodiments described herein to other wireless communication networks provided with necessary properties.

The example wireless communication network shown in FIG. 1 includes a radio access network (RAN) and a core network 110.

FIG. 1 shows user equipment (UE) 100, 102 configured to be in a wireless connection on one or more communication channels in a radio cell with an access node 104 of a radio access network.

The access node 104 may comprise a computing device configured to control the radio resources of the access node 104 and to be in a wireless connection with one or more UEs 100, 102. The access node 104 may also be referred to as a base station, a base transceiver station (BTS), an access point, a cell site, a network node, a radio access network node, a RAN node, or a network device.

The access node 104 may be, for example, an evolved NodeB (abbreviated as eNB or eNodeB), or a next generation evolved NodeB (abbreviated as ng-eNB), or a next generation NodeB (abbreviated as gNB or gNodeB), providing the radio cell. The access node 104 may include or be coupled to transceivers. From the transceivers of the access node 104, a connection may be provided to an antenna unit that establishes a bi-directional radio link to one or more UEs 100, 102. The antenna unit may comprise an antenna or antenna element, or a plurality of antennas or antenna elements.

The wireless connection (e.g., radio link) from a UE 100, 102 to the access node 104 may be called uplink (UL) or reverse link, and the wireless connection (e.g., radio link) from the access node 104 to the UE 100, 102 may be called downlink (DL) or forward link. A UE 100 may also communicate directly with another UE 102, and vice versa, via a wireless connection generally referred to as a sidelink (SL). It should be appreciated that the access node 104 or its functionalities may be implemented by using any node, host, server, access point or other entity suitable for providing such functionalities.

The radio access network may comprise more than one access node 104, in which case the access nodes may also be configured to communicate with one another over wired or wireless links. These links between access nodes may be used for sending and/or receiving control plane signaling and also for routing data from one access node to another access node.

The access node 104 may further be connected to a core network (CN) 110. The core network 110 may comprise an evolved packet core (EPC) network and/or a 5th generation core network (5GC). The EPC may comprise network entities, such as a serving gateway (S-GW for routing and forwarding data packets), a packet data network gateway (P-GW) for providing connectivity of UEs to external packet data networks, and/or a mobility management entity (MME). The 5GC may comprise one or more network functions, such as at least one of: a user plane function (UPF), an access and mobility management function (AMF), a location management function (LMF), and/or a session management function (SMF).

The core network 110 may also be able to communicate with one or more external networks 113, such as a public switched telephone network or the Internet, or utilize services provided by them. For example, in 5G wireless communication networks, the UPF of the core network 110 may be configured to communicate with an external data network via an N6 interface. In LTE wireless communication networks, the P-GW of the core network 110 may be configured to communicate with an external data network.

It should also be understood that the distribution of functions between core network operations and access node operations may differ in future wireless communication networks compared to that of the LTE or 5G, or even be non-existent.

The illustrated UE 100, 102 is one type of an apparatus to which resources on the air interface may be allocated and assigned. The UE 100, 102 may also be called a wireless communication device, a subscriber unit, a mobile station, a remote terminal, an access terminal, a user terminal, a terminal device, or a user device, just to mention but a few names. The UE 100, 102 may be a computing device operating with or without a subscriber identification module (SIM), including, but not limited to, the following types of computing devices: a mobile phone, a smartphone, a personal digital assistant (PDA), a handset, a computing device comprising a wireless modem (e.g., an alarm or measurement device, etc.), a laptop computer, a desktop computer, a tablet, a game console, a notebook, a multimedia device, a reduced capability (RedCap) device, a wearable device (e.g., a watch, earphones or eyeglasses) with radio parts, a sensor comprising a wireless modem, or a computing device comprising a wireless modem integrated in a vehicle.

It should be appreciated that the UE 100, 102 may also be a nearly exclusive uplink-only device, of which an example may be a camera or video camera loading images or video clips to a network. The UE 100, 102 may also be a device having capability to operate in an Internet of Things (IoT) network, which is a scenario in which objects may be provided with the ability to transfer data over a network without requiring human-to-human or human-to-computer interaction.

The wireless communication network may also be able to support the usage of cloud services. For example, at least part of core network operations may be carried out as a cloud service (this is depicted in FIG. 1 by “cloud” 114). The UE 100, 102 may also utilize the cloud 114. In some applications, the computation for a given UE may be carried out in the cloud 114 or in another UE.

The wireless communication network may also comprise a central control entity, such as a network management system (NMS), or the like. The NMS is a centralized suite of software and hardware used to monitor, control, and administer the network infrastructure. The NMS is responsible for a wide range of tasks such as fault management, configuration management, security management, performance management, and accounting management. The NMS enables network operators to efficiently manage and optimize network resources, ensuring that the network delivers high performance, reliability, and security.

5G enables using multiple-input and multiple-output (MIMO) antennas in the access node 104 and/or the UE 100, 102, many more base stations or access nodes than an LTE network (a so-called small cell concept), including macro sites operating in co-operation with smaller stations and employing a variety of radio technologies depending on service needs, use cases and/or spectrum available. 5G wireless communication networks may support a wide range of use cases and related applications including video streaming, augmented reality, different ways of data sharing and various forms of machine-type applications, such as (massive) machine-type communications (mMTC), including vehicular safety, different sensors and real-time control.

In 5G wireless communication networks, access nodes and/or UEs may have multiple radio interfaces, such as below 6 gigahertz (GHz), centimeter wave (cmWave) and millimeter wave (mmWave), and also being integrable with legacy radio access technologies, such as LTE. Integration with LTE may be implemented, for example, as a system, where macro coverage may be provided by LTE, and 5G radio interface access may come from small cells by aggregation to LTE. In other words, a 5G wireless communication network may support both inter-RAT operability (such as interoperability between LTE and 5G) and inter-RI operability (inter-radio interface operability, such as between below 6 GHz, cmWave, and mmWave).

5G wireless communication networks may also apply network slicing, in which multiple independent and dedicated virtual sub-networks (network instances) may be created within the same physical infrastructure to run services that have different requirements on latency, reliability, throughput and mobility.

In one embodiment, an access node 104 may comprise: a radio unit (RU) 103 comprising a radio transceiver (TRX), i.e., a transmitter (Tx) and a receiver (Rx); one or more distributed units (DUs) 105 that may be used for the so-called Layer 1 (L1) processing and real-time Layer 2 (L2) processing; and a central unit (CU) 108 (also known as a centralized unit) that may be used for non-real-time L2 and Layer 3 (L3) processing. The CU 108 may be connected to the one or more DUs 105 for example via an F1 interface. Such an embodiment of the access node 104 may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU 108 may be a logical node hosting radio resource control (RRC), service data adaptation protocol (SDAP) and/or packet data convergence protocol (PDCP), of the NR protocol stack for an access node 104. The CU 108 may comprise a control plane (CU-CP), which may be a logical node hosting the RRC and the control plane part of the PDCP protocol of the NR protocol stack for the access node 104. The CU 108 may further comprise a user plane (CU-UP), which may be a logical node hosting the user plane part of the PDCP protocol and the SDAP protocol of the CU for the access node 104.

The DU 105 may be a logical node hosting radio link control (RLC), medium access control (MAC) and/or physical (PHY) layers of the NR protocol stack for the access node 104. The operations of the DU 105 may be at least partly controlled by the CU 108. It should also be understood that the distribution of functions between the DU 105 and the CU 108 may vary depending on the implementation.

Cloud computing systems may also be used to provide the CU 108 and/or DU 105. A CU provided by a cloud computing system may be referred to as a virtualized CU (vCU). In addition to the vCU, there may also be a virtualized DU (vDU) provided by a cloud computing system. Furthermore, there may also be a combination, where the DU may be implemented on so-called bare metal solutions, for example application-specific integrated circuit (ASIC) or customer-specific standard product (CSSP) system-on-a-chip (SoC).

Edge cloud may be brought into the radio access network by utilizing network function virtualization (NFV) and software defined networking (SDN). Using edge cloud may mean access node operations to be carried out, at least partly, in a computing system operationally coupled to a remote radio head (RRH) or a radio unit (RU) 103 of an access node 104. It is also possible that access node operations may be performed on a distributed computing system or a cloud computing system located at the access node 104. Application of cloud RAN architecture enables RAN real-time functions being carried out at the radio access network (e.g., in a DU 105), and non-real-time functions being carried out in a centralized manner (e.g., in a CU 108).

5G (or new radio, NR) wireless communication networks may support multiple hierarchies, where multi-access edge computing (MEC) servers may be placed between the core network 110 and the access node 104. It should be appreciated that MEC may be applied in LTE wireless communication networks as well.

A 5G wireless communication network (“5G network”) may also comprise a non-terrestrial communication network, such as a satellite communication network, to enhance or complement the coverage of the 5G radio access network. For example, satellite communication may support the transfer of data between the 5G radio access network and the core network 110, enabling more extensive network coverage. Possible use cases may include: providing service continuity for machine-to-machine (M2M) or Internet of Things (IoT) devices or for passengers on board of vehicles, or ensuring service availability for critical communications, and future railway, maritime, or aeronautical communications. Satellite communication may utilize geostationary earth orbit (GEO) satellite systems, or low earth orbit (LEO) satellite systems, such as mega-constellations (i.e., systems in which hundreds of (nano) satellites are deployed).

Alternatively, the satellites may be an airborne devices, such as an unmanned aerial vehicle (UAV), or a high-altitude platform system (HAPS). A given satellite 106 may provide communication services on Earth via one or more satellite beams. The one or more satellite beams create one or more cells over a given service area that may be bounded by the field of view of the satellite 106.

It is obvious for a person skilled in the art that the access node 104 depicted in FIG. 1 is just an example of a part of a radio access network, and in practice the radio access network may comprise a plurality of access nodes 104, the UEs 100, 102 may have access to a plurality of radio cells, and the radio access network may also comprise other apparatuses, such as physical layer relay access nodes or other entities. At least one of the access nodes may be a Home eNodeB or a Home gNodeB. A Home gNodeB or a Home eNodeB is a type of access node that may be used to provide indoor coverage inside a home, office, or other indoor environment.

Additionally, in a geographical area of a radio access network, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) 104 of FIG. 1 may provide any kind of these cells. A cellular radio network may be implemented as a multilayer access networks including several kinds of radio cells. In multilayer access networks, one access node may provide one kind of a radio cell or radio cells, and thus a plurality of access nodes may be needed to provide such a multilayer access network.

For fulfilling the need for improving performance of radio access networks, the concept of “plug-and-play” access nodes may be introduced. A radio access network, which may be able to use “plug-and-play” access nodes, may include, in addition to Home eNodeBs or Home gNodeBs, a Home Node B gateway (HNB-GW) (not shown in FIG. 1). An HNB-GW, which may be installed within an operator's radio access network, may aggregate traffic from a large number of Home eNodeBs or Home gNodeBs back to a core network 110 of the operator.

6G wireless communication networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

5G NR involves beamforming (BF) in both FR1 with digital BF, and in FR2 with analog BF. The former allows for more flexibility as new beams may be computed at runtime to improve KPIs. This may be advantageous in TDD where the reciprocities of the channels in UL and DL allow for more performance on the BF algorithm. Digital BF allows the gNB to use the geometry of the antenna array to create or receive spatially selective signals. Beamforming is an act to create constructive interferences to reinforce the signal towards the UE and destructive interference to decrease interferences in unwanted directions. It may further be ensured that the beams associated with each layer of the UE are as orthogonal as possible; even though the UE equalizer may make received layers orthogonal, which may result in SINR reduction. The better optimized the layer transmission is at the transmitter side, the higher the received SINR may be. Thus, improving spatial orthogonality of the layers through customized beams, may reduce inter-layer interference and thus increase the channel capacity. To enable efficient computation for these beams, a channel sounding may be performed regularly through the reception by the gNB of UE-specific sounding signals (SRS in 5G 3GPP). The gNB may use uses this information to analyze the spatial propagation channel of the UE and to optimize the computation of beam weight (BW) vectors. This step, which may be called precoding, may be computationally intensive and time sensitive, and may thus be handled in the real time part of the system (gNB-DU or RU).

Mathematical methods, such as eigen beam, zero forcing, exist for computing different BW vectors, depending on a tradeoff between functional requirements, expected performance and computation cost. Most of them have high computational complexity with the least computationally intensive as such methods require a matrix inversion.

A solution compatible with computational complexity affordable in hardware, may be to estimate received energy using a predefined set of BW vectors. Received energy by an antenna array may be estimated using the predefined set of the beam weigth vectors. For each vector, the received energy by an antenna array may be predicted mathematically using a spatial channel covariance matrix, built from channel estimation that may be extracted from sounding signals sent by the UE. Then, using a GoB (grid of beam) method, the beam weights may be selected among a set of predefined values. Each element of the set may represent a beam pointing to a different direction, spanning a given horizontal and vertical angle of an overall RU coverage and effectively forming a grid of the RU overall coverage using beams. By estimating the azimuth and elevation direction having the strongest power in the estimated channel and mapping it to the corresponding beam in the GoB, the throughput may be optimized. To cap the throughput with more than one beam (in case of MIMO), additional selection criteria may need to be considered, such as direction orthogonality from the transmission perspective. Massive MIMO (mMIMO) is an extension of the MIMO system, increasing the number of antennas in the base station(s). Each additional beam selection for the transmission may thus bring additional constraints on the next one leading to extra computational complexity. One implementation may be sounding based beamforming. However, the large amount of computation still needed may limit the number of UEs in a slot that may be served with sounding based beamforming.

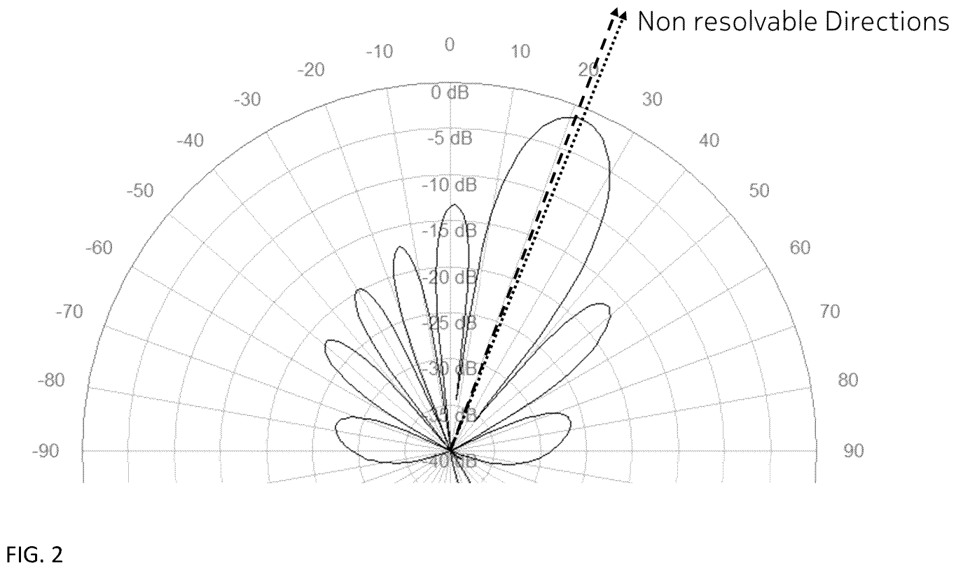

The gNB may analyse the sounding signals emitted by the UE through its antenna array to detect the direction of the different propagation paths and optimize its transmission toward the UE. Spatial differentiation of propagation paths may be needed. However, it is not necessarily possible to differentiate each path. Paths that are too close together in terms of direction may be seen by the gNB as a single cluster of paths that is to be addressed as a whole during transmission. An example of such a case is illustrated in FIG. 2, representing two non-resolvable directions in an antenna array pattern. The spatial granularity of the gNB to differentiate between direction may depend solely on the numbers of TRX in the RU antenna and its azimuth and elevation apertures. A cluster of paths that cannot be differentiated and that may be used for different layer transmission, may have a heavily degraded SINR and may offer poor performance. The angular resolvability of the gNB antenna array may thus have a direct impact on the performance.

Some close propagation direction(s) may still be resolved in the time domain, as the propagation delays may be differentiated using mathematical methods. However, the resolvability of different propagation paths in the time domain may be dependent on cyclic autocorrelation of the waveforms used for channel sounding (for instance, the SRS defined in 3GPP for 5G). Consequently, the space/time resolvability of the propagation paths may be limited by the encompassing antenna array resolvability and sounding channel time domain resolvability. The space/time resolvability may be limited by the antenna array resolvability. The antenna array resolvability is a static property of geometric parameters of the antenna array, which are independent of the channel properties. The space/time resolvability may be limited by the channel delay distribution.

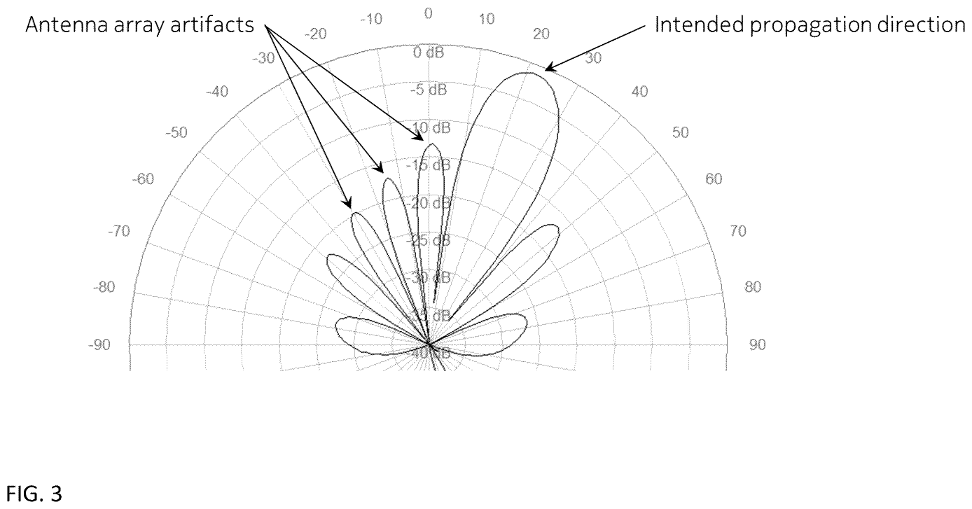

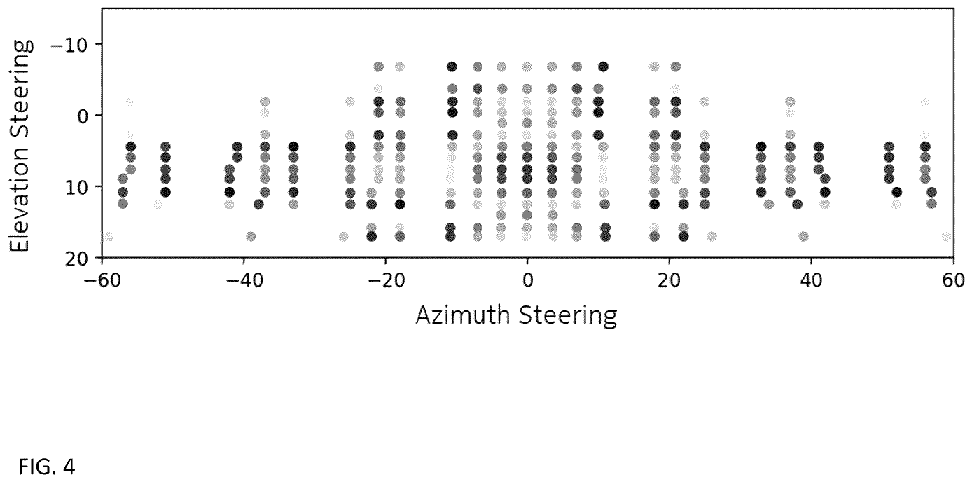

The antenna array used by the RU to form beams may inherently be a discrete system sampling the spatial domain. By focusing a beam on a particular direction, multiple artifacts may be created in other directions (i.e. secondary or side lobes), causing unwanted propagation directions and dominant directions. Due to the reciprocity of the channel in the TDD, these artifacts may affect both the transmission and reception. Thus, when estimating the channel through the sounding signals, artifacts may appear in the estimated channel due to side lobes of each beam constituting the GoB. The side lobes may be reduced e.g. by tapering, but that may decrease the transmitted power, because uneven power per TRX, on top of phase differences, may be required. The GoB solution may use its beam grid and the spatial diversity of the channel to find the optimal beam for the different layers. However, such a solution may not work in a sparse multi-path environment (i.e. in an environment with limited reflective/deflective surfaces) in close range such as an open field, or in limited presence of building and trees. In that case, the LoS component of the channel propagation may dominate the channel estimation done through the sounding signals, and the side lobes from the receiving beam in the GoB may create powerful artifacts in the estimated channel that may overshadow potential beam candidates. Under such limitations, the artifacts from the dominant propagation cluster may hide other propagation paths. An example of such artifacts is presented in FIG. 3, illustrating antenna array artifacts in a beam pattern. This behavior may be extended to each channel with a given dominant non-resolvable spatial cluster of propagation paths (i.e. a set of paths clustered together that have a dominant contribution to the channel propagation and need to be addressed as a single direction by the gNB). In that case, finding the right propagation paths may be more challenging for the reference GoB based algorithm, and it may be necessary to adjust the relative contribution of each path by using the power budget available in the RU to reach the best performance. An example of the effect of a dominant propagation path on the channel seen by the gNB is presented in FIG. 4. FIG. 4 illustrates angular distribution of the received energy by the antenna array from a single narrow illumination at 0° azimuth and +8° elevation seen through a GoB. This effect may be resolved using a mathematical method that may rely on computing the eigen vector decomposition of the spatial covariance matrix. Such decomposition has a complexity in O(n³) which may be computationally expensive, as the spatial matrix may have a square dimension of at least the number of TRX on the gNB (which may be 32 or 64 in a standard 5G-NR deployment). This may limit the directional coupling resolvability of the antenna array, especially with strong LOS and/or when dominant propagation exists. Even though the resolvability of the channel may thus be addressed, the solution may have a high complexity. This may impose a limit on the number of users served in a time constrained environment.

The non-resolvability of microscale propagations may be caused by the proximity of the propagation directions, the geometrical artifacts of the antenna array, or the subsequent non-resolvability in time domain. An embodiment analyses resolvable cluster channels (RCC) that may be constituted by the aggregation of the non-resolvable microscale propagations received through the antenna array. Two RCCs that may be differentiated from one another may be referred to as separable, and an RCC that overshadows other propagation directions may be referred to as a dominant RCC (D-RCC).

An embodiment may involve precoding through channel estimation. Instead of using the channel estimation from the sounding signals directly to select beams, an embodiment may use the channel estimation to model the D-RCC, and may offer a more cost-effective approach for the gNB-DU or RU to optimize transmission and reception towards the UE. Two channel estimations may be derived: one being the channel resulting from the D-RCC, and the other being the residual channel pruned from the dominant contribution. By design, the two separate channels may be orthogonal. Thus, the precoder may immediately use the D-RCC to derive a beam for the first layer, without having to consider other channels as they are implicitly managed by the construction of the D-RCC. In an embodiment, precoding in the massive MIMO system may be simplified using channel extraction.

In an embodiment, an apparatus may, based on an initial channel estimation of sounding signals, perform channel extraction by extracting a propagation channel into a dominant resolvable cluster channel model and a residual channel model. The apparatus may use the dominant resolvable cluster channel model as an input to precoding with a channel model precoder.

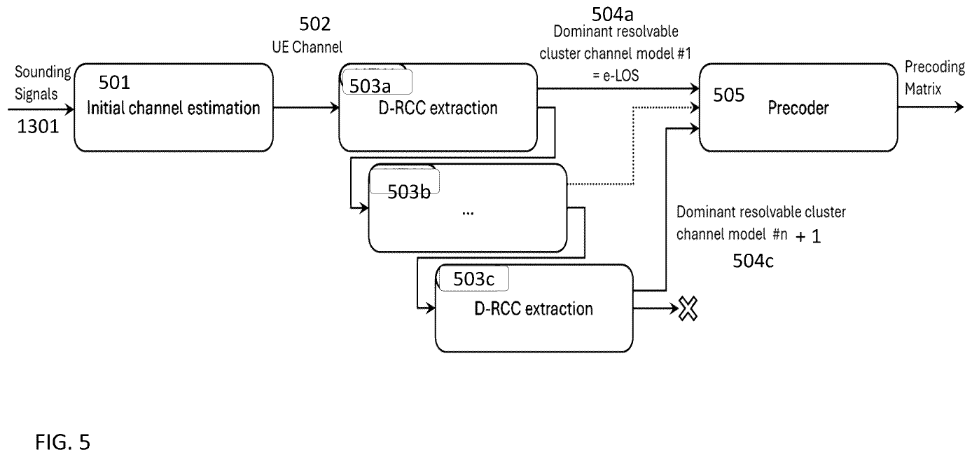

In an embodiment, the D-RCC extraction may be chained, if the pruned channel from a previous extraction exhibits a new D-RCC. This may further improve the performance by providing inputs to the precoder that are easier to process, reducing the number of iterations required to select a beam for each layer. FIG. 5 illustrates sounding signals processing according to an embodiment, illustrating a sounding signals processing chain.

An embodiment may reduce the complexity of the algorithm to be used (the solution may be in the range of O[n²]) and enable good performance in spatially sparse and dominated channels. The antenna array limitations may be implicitly managed; the D-RCCs and the pruned extracted channels may be mutually orthogonal. The extracting may be iteratively chained to further improve the performance when the extracted channel presents a new D-RCC. The mobile network systems may have high probability to iteratively find the D-RCCs.

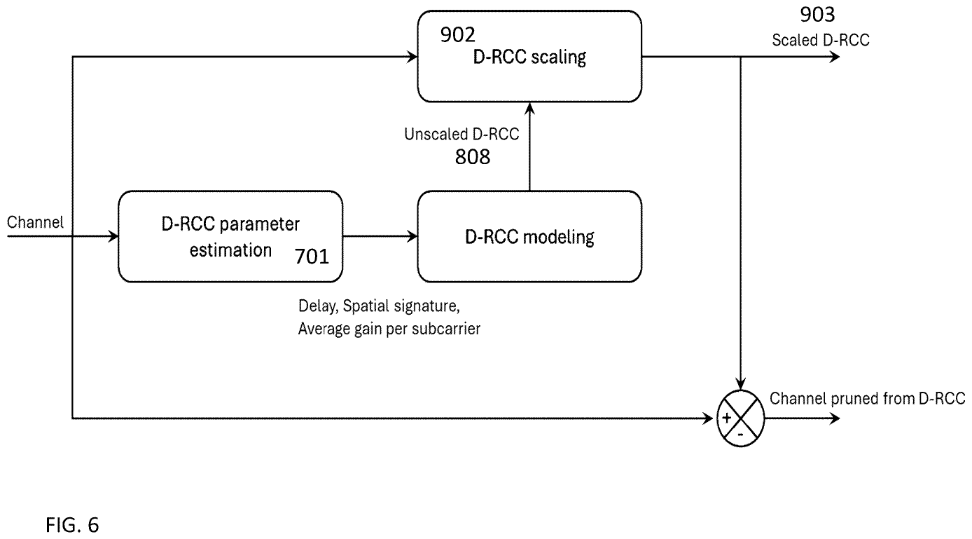

An embodiment may improve performance and reduce computational complexity in channels that are spatially sparse and present a D-RCC. An embodiment may comprise receiving as an input the channel estimated from the UE sounding signals, and returning as an output two separate outputs. A first output may be a channel representing the propagation of the D-RCC. A second output may be an input channel pruned from the D-RCC propagation which may thus be orthogonal to the dominant propagation paths. This may ensure the orthogonality required for MIMO transmissions without further orthogonality constraints. FIG. 6 illustrates D-RCC channel extraction according to an embodiment.

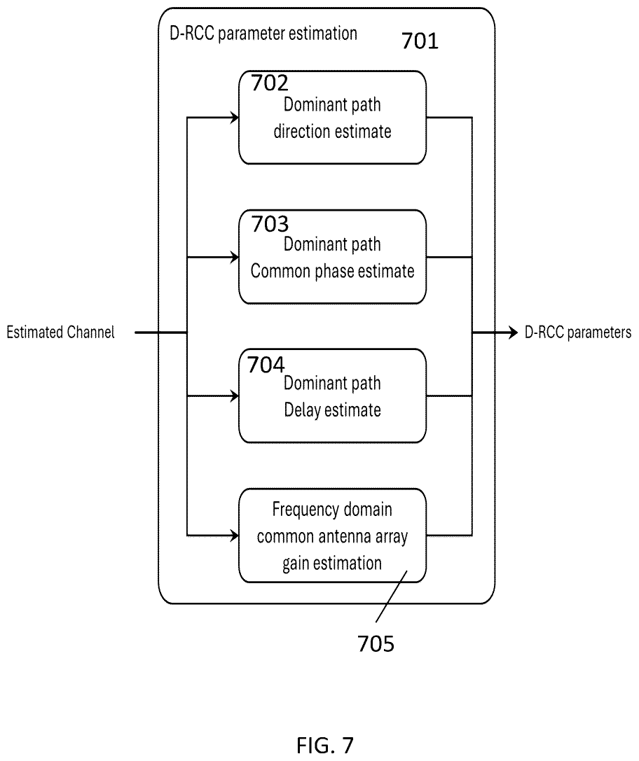

In an embodiment, to derive the D-RCCs, the associated propagation parameters may be determined from the estimated channel: propagation direction, propagation delay, and average channel gain per subcarrier. Due to the propagation path being dominant, simplified processes may be used that neglect the effects of other propagation paths. FIG. 7 illustrates D-RCC parameter estimation according to an embodiment.

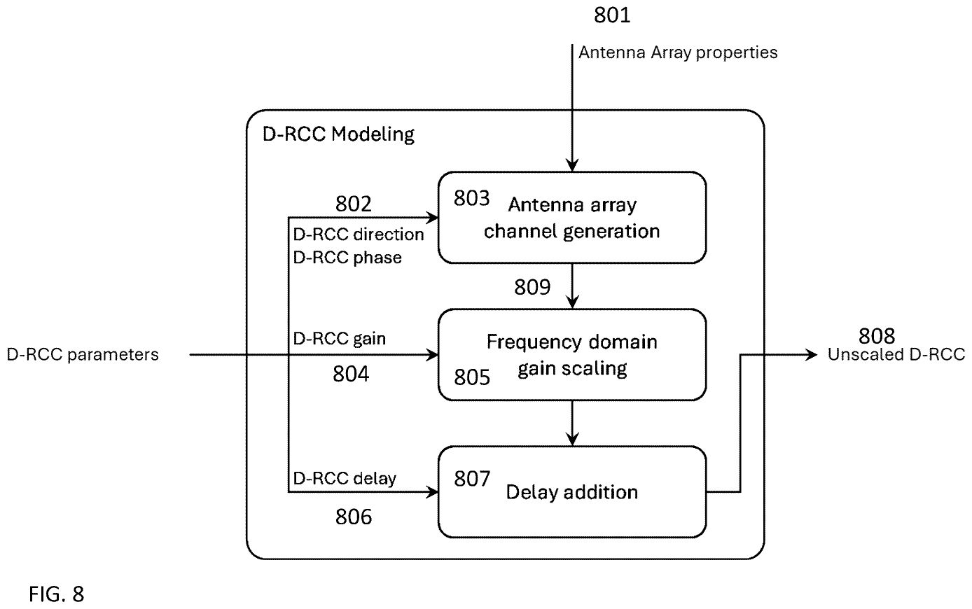

In an embodiment, the D-RCC may be modelled using the estimated D-RCC parameters and antenna array geometric parameters. The channel created as the D-RCC may differ from a real channel depending on the quality of the parameter estimation. FIG. 8 illustrates D-RCC modelling according to an embodiment.

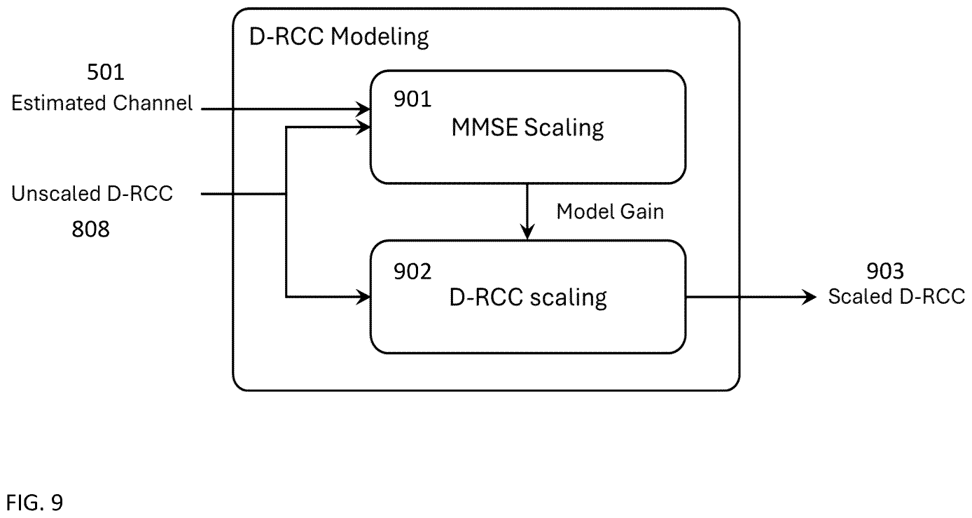

In an embodiment, once the model is computed, a minimum mean square error (MMSE) process may be used to minimize power error between the model and the real channel. Because the channel power may be dominated by the D-RCC, the channel power may be almost equal to a real D-RCC channel. Thus, optimum scaling may be achieved. Scaling quality may depend on the domination of the RCC. The more prevalent the D-RCC is, the more accurate the scaling may be, and vice versa. FIG. 9 illustrates D-RCC scaling according to an embodiment.

In an embodiment, the scaled D-RCC channel model may be subtracted from the input channel model, as illustrated in FIG. 5, to create the pruned channel model. The pruned channel model may be orthogonal to the scaled D-RCC model.

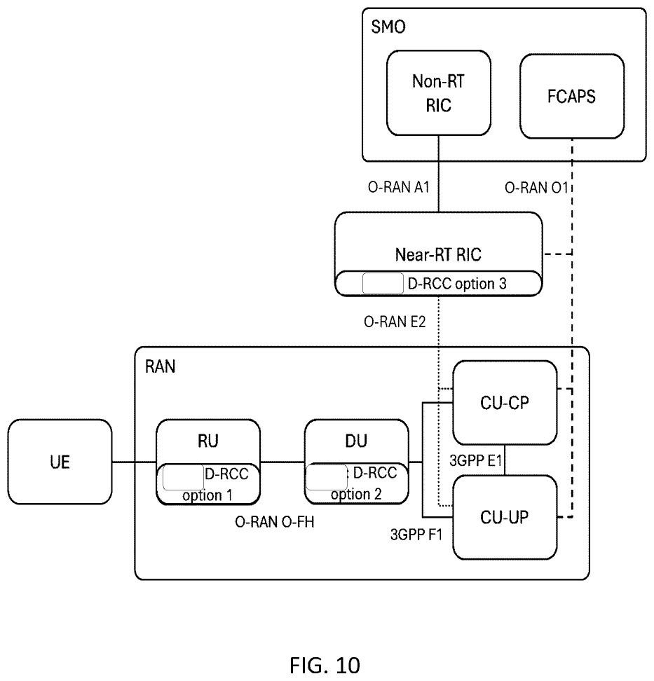

FIG. 10 illustrates deployment options for the D-RCC extraction in O-RAN (open RAN) environments. For example, one option (“option 1” in FIG. 10) to implement the beam selection and the D-RCC extraction may be deployment in the DU in 5G. Further options (“option 2”, “option 3” in FIG. 10) may involve other O-RAN options where the beam selection and D-RCC extractions may be performed in the near real time radio intelligent controller (near-RT RIC). SMO refers to service management and orchestration. FCAPS refers to fault, configuration, accounting, performance and security, which is a network management framework and model created by the International Organization for Standardization (ISO). A1, O1, E2, O-FH, F1, E1 illustrate various interfaces of the network system.

The first deployment option (option 1) may be implementation in the RU in cases where the beams are computed in the RU. This may enable the best possible latency, but the available resources for the computation may be constrained by the real time nature of the RU.

The second deployment option (option 2) may be implementation in the DU. This may offer a very good latency but perform the computation in an already heavily loaded system. The beams computation may be carried out whenever the UEs with high resource usage are present, i.e. when the system is strained. The D-RCC extraction may enable to alleviate the stress of the DU and the system and serve more UEs with optimal beams.

The third deployment option (option 3) may be implementation in the RIC. This may present a higher latency and a multiplied number of users, as the RIC may be used for multiple CUs and Dus. However, the RIC may scale its computational resources depending on the demand. The RIC in the O-RAN network may be responsible for optimizing slicing, mobility, load balancing and radio link management, etc. In the future, these tasks may be partly carried out using AI/ML technology which may be very demanding in terms of resources. Thus, the D-RCC solution may be able to reduce the load on the RIC by speeding up the analysis of the sounding signals for beam selections from numerous UEs, while offering new inputs to the AI/ML algorithms running in parallel.

An exemplary method was tested on various channels. A good performance was observed. To demonstrate the rejection capability of the method, an artificial channel was created with 1 LoS dominant propagation and 4 other propagations that were 15 dB to 23 dB lower from LoS (see Table 1).

TABLE 1

| | | | | Relative |
|---|---|---|---|---|
| | Relative | Elevation | Azimuth | propagation |
| Propagation | power (dB) | AoA (°) | AoA (°) | distance (m) |
| D-RCC (LOS) | 0 | −26 | 9 | 0 |
| RCC #1 | −15 | −15 | 11 | 50 |
| RCC #2 | −20 | −34 | 9 | 100 |
| RCC #3 | −20 | 11 | 13 | 200 |
| RCC #4 | −23 | 26 | 1 | 150 |

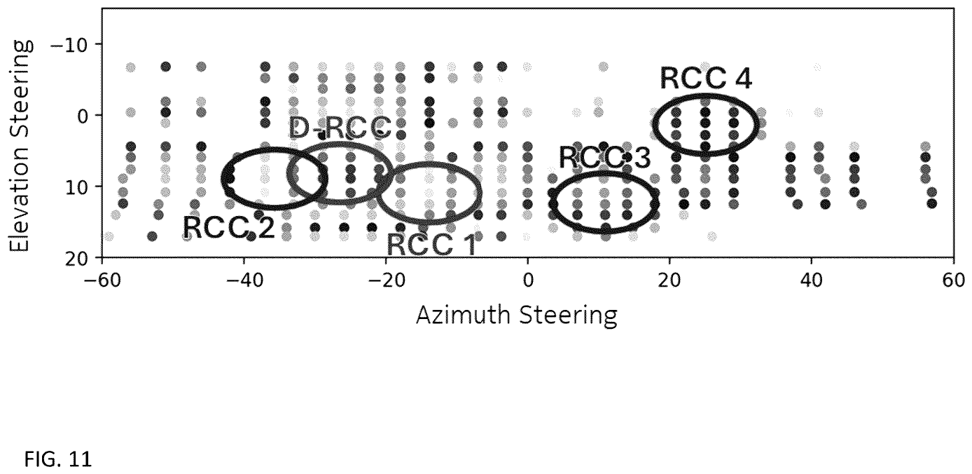

FIG. 11 illustrates test results for a complete estimate channel of sounding signals, observed through various directions of arrival, illustrating the dominance from LoS propagation (first propagation path). As it may be seen from FIG. 11, all 4 additional propagations were not clearly identified.

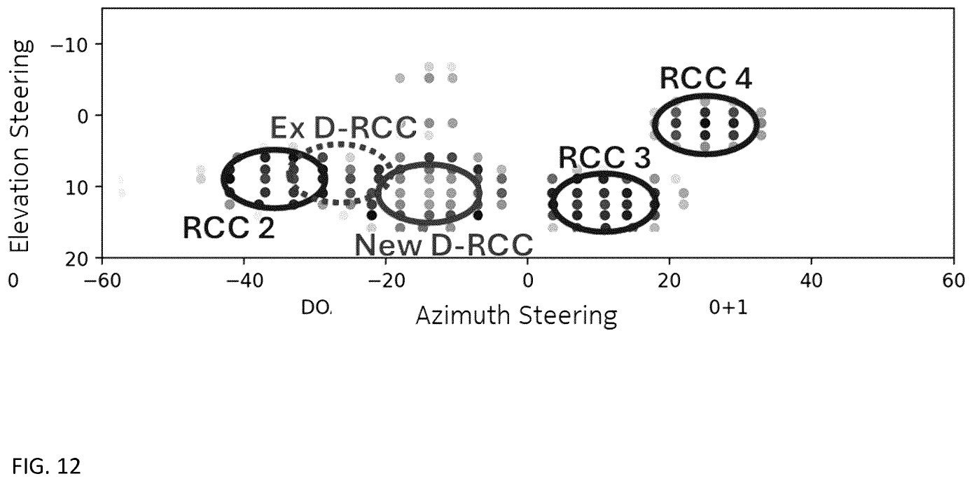

FIG. 12 illustrates test results for the channel pruned from the D-RCC. In the residual channel, all 4 other propagations were identified, which were detected in correct angular coordinates. Some remaining power was observed where the D-RCC was pruned: this power may be linked to propagations paths in a different resolvable, time domain transmission.

An embodiment enables a tradeoff between computational cost and performance. The complexity of computing beams for the UE may be reduced.

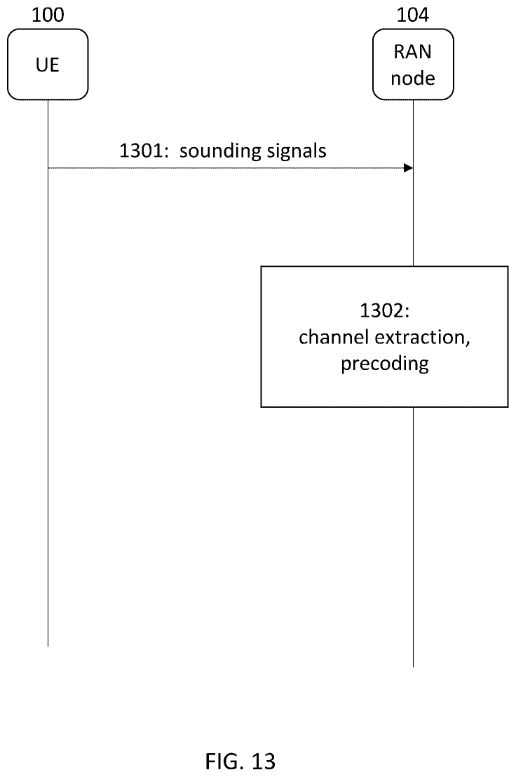

FIG. 13 illustrates an exemplary method. Referring to FIG. 13 and/or FIG. 5, an apparatus which may be a RAN node 104, such as a radio unit, base station or a gNB-DU, may receive, at 1302, sounding signals 1301 transmitted by a user equipment (UE) 100 or terminal device. Further, at 1302, the apparatus may, based on an initial channel estimation 501 of the sounding signals 1301, perform channel extraction 503a by extracting a propagation channel 502 into a first dominant resolvable cluster channel model 504a and a first residual channel model. Yet further, at 1302, the apparatus may use the first dominant resolvable cluster channel model 504a as a first input to precoding with a channel model precoder 505.

The apparatus 104 may, at 1302, perform further channel extraction 503b by extracting the first residual channel model into a second dominant resolvable cluster channel model and a second residual channel model, and use the second dominant resolvable cluster channel model as a second input to the precoding with the channel model precoder 505.

The extracting may be iteratively chained to further improve the performance of the extracted channel. The apparatus 104 may perform yet further channel extraction 503c by extracting an Nth residual channel model into an (N+1)th dominant resolvable cluster channel model 504c and an (N+1)th residual channel model. The Nth residual channel model may be obtained by performing channel extraction by extracting an (N−1)th residual channel into the Nth dominant resolvable cluster channel model and an Nth residual channel model. The apparatus 104 may use the (N+1)th dominant resolvable cluster channel model as an (N+1)th input to the precoding with the channel model precoder 505. N may be any positive integer. For example, N may be {2, 3, 4, . . . }. For example, depending on the number of iterations, N may be any positive integer {2, 3, 4, . . . , 5}, {2, 3, 4, . . . , 10}, or {2, 3, 4, . . . , 15}.

The apparatus 104 may use a dominant resolvable cluster channel model 504a, 504c as an input for performing beam selection. The dominant resolvable cluster channel model and a corresponding residual channel model may be orthogonal compared to each other.

Referring to FIG. 7, in order to extract the dominant resolvable cluster channel model, an estimation 701 of channel propagation parameters may be performed. The channel propagation parameters may be selected from one or more of
dominant propagation path direction 702,
dominant propagation path common phase 703,
dominant propagation path delay 704,
average channel gain per subcarrier 705.

Referring to FIG. 8, the apparatus 104 may generate 803 an antenna array channel model based on the antenna array geometric parameters 801, the dominant propagation path direction 802, and the dominant propagation path common phase 802. The apparatus 104 may perform frequency domain channel gain scaling 805 based on the antenna array channel model 809, and the average channel gain 804 per subcarrier. Then the apparatus 104 may perform delay addition 807 based on the dominant propagation path delay 806. The apparatus may obtain as a first output an unscaled dominant resolvable cluster channel model 808.

Referring to FIG. 9, the apparatus 104 may perform minimum mean square error computation 901 based on: the unscaled dominant resolvable cluster channel model 808 and the initial channel estimation 501 of the sounding signals 1301. Thus, a correction gain may be computed using the mean square error process. The apparatus 104 may perform dominant resolvable cluster channel scaling 902 based on the minimum mean square error computation 901, and obtain as a further output a scaled dominant resolvable cluster channel model 903.

The apparatus 104 may subtract the scaled dominant resolvable cluster channel model 903 from the initial channel estimation 501 of the sounding signals 1301 to obtain a residual channel model, or the apparatus 104 may subtract the scaled dominant resolvable cluster channel model 903 from an Nth residual channel model to obtain an (N+1)th residual channel model.

The apparatus 104 may perform the channel extraction 1302 by extracting the propagation channel 502 into the first dominant resolvable cluster channel model 504a and the first residual channel model, upon a dominant resolvable cluster channel being available.

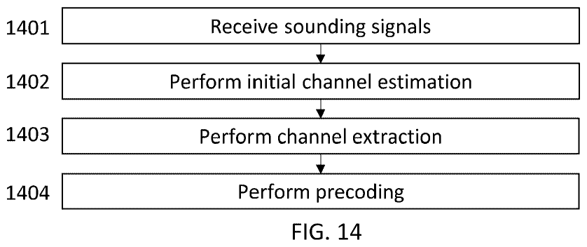

FIG. 14 is a flow chart illustrating an exemplary method. Referring to FIG. 14, an apparatus which may be a RAN node 104, such as a radio unit, base station or a gNB-DU, may receive, at 1401, sounding signals transmitted by a user equipment (UE) 100 or terminal device. At 1402, the apparatus 104 may, perform an initial channel estimation of the sounding signals. At 1403, the apparatus 104 may, based on the initial channel estimation of the sounding signals, perform channel extraction 1403 by extracting a propagation channel into a first dominant resolvable cluster channel model and a first residual channel model. At 1404, the apparatus may use the first dominant resolvable cluster channel model as a first input to precoding with a channel model precoder.

In an embodiment, there is provided a system comprising at least one processor and at least one memory storing instructions that, when executed by the at least one processor, cause the system to perform any the method steps.

The blocks, related functions, and information exchanges (messages) described above by means of FIGS. 2 to 14 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, the terms “the at least one” and “the one or more” mean “any one of the at least one” and “any one of the one or more”, respectively.

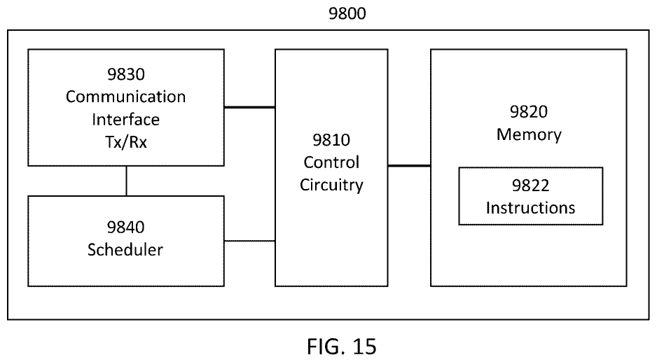

FIG. 15 illustrates an example of an apparatus 9800 comprising means for causing the apparatus 9800 to perform one or more of the example embodiments (e.g., the method of FIG. 14) described above. For example, the apparatus 9800 may be an apparatus such as, or comprising, or comprised in, a network node 104 of a radio access network, such as a a radio unit or a gNB-DU.

The apparatus 9800 may comprise, for example, a circuitry or a chipset applicable for realizing one or more of the example embodiments described above. The apparatus 9800 may be an electronic device comprising one or more electronic circuitries. The apparatus 9800 may comprise a communication control circuitry 9810 such as at least one processor, and at least one memory 9820 storing instructions 9822 which, when executed by the at least one processor, cause the apparatus 9800 to carry out one or more of the example embodiments described above. Such instructions 9822 may, for example, include computer program code (software). The at least one processor and the at least one memory storing the instructions may provide the means for providing or causing the performance of any of the methods and/or blocks described above.

The processor is coupled to the memory 9820. The processor is configured to read and write data to and from the memory 9820. The memory 9820 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 9820 stores computer readable instructions that are executed by the processor. For example, non-volatile memory stores the computer readable instructions, and the processor executes the instructions using volatile memory for temporary storage of data and/or instructions.

The computer readable instructions may have been pre-stored to the memory 9820 or, alternatively or additionally, they may be received, by the apparatus, via an electromagnetic carrier signal and/or may be copied from a physical entity such as a computer program product. Execution of the computer readable instructions causes the apparatus 9800 to perform one or more of the functionalities described above.

The memory 9820 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data, such as a current neighbour cell list, and, in some example embodiments, structures of frames used in the detected neighbour cells.

The apparatus 9800 may further comprise or be connected to a communication interface 9830, such as a radio unit, comprising hardware and/or software for realizing communication connectivity with one or more wireless communication devices according to one or more communication protocols. The communication interface 9830 comprises at least one transmitter (Tx) and at least one receiver (Rx) that may be integrated to the apparatus 9800 or that the apparatus 9800 may be connected to. The communication interface 9830 may provide means for performing some of the blocks and/or functions (e.g., transmitting and receiving) for one or more example embodiments described above. The communication interface 9830 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

The communication interface 9830 provides the apparatus with radio communication capabilities to communicate in the wireless communication network. The communication interface may, for example, provide a radio interface to one or more UEs 100, 102. The apparatus 9800 may further comprise or be connected to another interface towards a core network 110, such as the network coordinator apparatus or AMF, and/or to other access nodes of the wireless communication network.

The apparatus 9800 may further comprise a scheduler 9840 that is configured to allocate radio resources. The scheduler 9840 may be configured along with the communication control circuitry 9810 or it may be separately configured.

It is to be noted that the apparatus 9800 may further comprise various components not illustrated in FIG. 15. The various components may be hardware components and/or software components.

As used in this application, the term “circuitry” may refer to one or more or all of the following: a) hardware-only circuit implementations (such as implementations in analog, digital and/or quantum circuitry); and b) combinations of hardware circuit(s) and software, such as (as applicable): i) a combination of analog, digital and/or quantum hardware circuit(s) with software/firmware and ii) any or all portions of hardware processor(s) (including digital and/or quantum processor(s)) with software, and memory (ies) that work together to cause an apparatus, such as a mobile device, computing device, or server, to perform various functions; and c) any or all portions of hardware circuit(s), such as microprocessor(s), processor(s) and/or quantum processor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be understandable to a person skilled in the art that, as technology advances, the proposed concept may be implemented in various ways within the scope of the claims. The embodiments are not limited to the example embodiments described above, but may vary within the scope of the claims. Therefore, all words and expressions should be interpreted broadly, and they are intended to illustrate, not to restrict, the embodiments.

1. An apparatus comprising at least one processor, and at least one memory storing instructions that, when executed by the at least one processor, cause the apparatus at least to:
based on an initial channel estimation of sounding signals, perform channel extraction by extracting a propagation channel into a first dominant resolvable cluster channel model and a first residual channel model; and
use the first dominant resolvable cluster channel model as a first input to precoding with a channel model precoder.

2. The apparatus according to claim 1, being caused to:
perform the channel extraction by extracting the propagation channel into the first dominant resolvable cluster channel model and the first residual channel model, upon the first dominant resolvable cluster channel being available.

3. The apparatus according to claim 1, further being caused to:
perform channel extraction by extracting the first residual channel model into a second dominant resolvable cluster channel model and a second residual channel model; and
use the second dominant resolvable cluster channel model as a second input to the precoding with the channel model precoder.

4. The apparatus according to claim 3, being caused to:
perform the channel extraction by extracting the first residual channel model into the second dominant resolvable cluster channel model and the second residual channel model, upon the second dominant resolvable cluster channel being available.

5. The apparatus according to claim 1, further being caused to:
perform channel extraction by extracting an Nth residual channel model into an (N+1)th dominant resolvable cluster channel model and an (N+1)th residual channel model,
wherein the Nth residual channel model is obtained by performing channel extraction by extracting an (N−1)th residual channel into the Nth dominant resolvable cluster channel model and an Nth residual channel model; and
use the (N+1)th dominant resolvable cluster channel model as an (N+1)th input to the precoding with the channel model precoder.

6. The apparatus according to claim 5, being caused to:
perform the channel extraction by extracting the Nth residual channel model into the (N+1)th dominant resolvable cluster channel model and the (N+1)th residual channel model, upon the (N+1)th dominant resolvable cluster channel being available.

7. The apparatus according to claim 1, wherein a dominant resolvable cluster channel model and a corresponding residual channel model are orthogonal compared to each other.

8. The apparatus according to claim 1, being caused to, in order to extract the dominant resolvable cluster channel model, estimate channel propagation parameters selected from one or more of
dominant propagation path direction,
dominant propagation path common phase,
dominant propagation path delay,
average channel gain per subcarrier.

9. The apparatus according claim 8, further being caused to:
generate an antenna array channel model based on the antenna array geometric parameters, the dominant propagation path direction, and the dominant propagation path common phase;
perform frequency domain channel gain scaling based on the antenna array channel model and the average channel gain per subcarrier;
perform delay addition based on the dominant propagation path delay; and
obtain as a first output an unscaled dominant resolvable cluster channel model.

10. The apparatus according to claim 9, being caused to:
perform minimum mean square error computation based on: the unscaled dominant resolvable cluster channel model and the initial channel estimation of the sounding signals;
perform dominant resolvable cluster channel scaling, based on the minimum mean square error computation; and
obtain as a further output a scaled dominant resolvable cluster channel model.

11. The apparatus according to claim 10, being caused to:
subtract the scaled dominant resolvable cluster channel model from the initial channel estimation of the sounding signals to obtain a residual channel model; or
subtract the scaled dominant resolvable cluster channel model from an Nth residual channel model to obtain an (N+1)th residual channel model.

12. The apparatus according to claim 1, wherein it is or comprises a radio unit or a gNB-DU.

13. A method comprising:
based on an initial channel estimation of sounding signals, performing, by an apparatus, channel extraction by extracting a propagation channel into a first dominant resolvable cluster channel model and a first residual channel model; and
using, by the apparatus, the first dominant resolvable cluster channel model as a first input to precoding with a channel model precoder.

14. A non-transitory computer readable medium comprising program instructions which, when executed by an apparatus, cause the apparatus to perform at least the following:
based on an initial channel estimation of sounding signals, performing channel extraction by extracting a propagation channel into a first dominant resolvable cluster channel model and a first residual channel model; and
using the first dominant resolvable cluster channel model as a first input to precoding with a channel model precoder.
